(19) United States
(12) Patent Application Publication
(10) Pub. No.: US 2012/0219846 A1
(43) Pub. Date: Aug. 30, 2012

(54) BATTERY CELL SUPPORT AND ASSEMBLY THEREOF

(76) Inventor: Yet Chan, Kwun Tong (HK)

(21) Appl. No.: 13/035,154

(22) Filed: Feb. 25, 2011

(51) Int. Cl. H01M 2/10; H01M 10/04

(52) U.S. Cl. 429/159; 29/428

(57) ABSTRACT

The present invention discloses a battery cell support consisted of a first supporting member and a second supporting member, which are assembled by a first fitting mechanism and a second fitting mechanism on the supporting member that can be snap-fit in each other. Battery cells are inserted in the space formed by the first supporting member and the second supporting member with exposed surface such that proper heat dissipation of the battery cells is ensured. An assembly of multiple battery cell supports is also disclosed which uses different fitting mechanisms to combine the separate battery cell supports, and also a metal strap is used to electrically connect the separate battery cell supports.

### FIELD OF INVENTION

This invention relates to a battery cell packing apparatus, and in particular a modular battery cell pack and the assembly thereof.

### BACKGROUND OF INVENTION

Presently, there are various types of rechargeable batteries available in the market, such as lead-acid batteries, nickel-cadmium batteries, nickel-hydrogen batteries, and Li-ion batteries, etc. Most battery manufacturers assemble battery cells in parallel or in series into battery products with certain power capacity at a common voltage. However, traditionally most manufacturers employ heat-shrinkable film to fix the assembled battery cells. Such an approach not only results in low production efficiency but also has a drawback that the heat produced in battery charge/discharge process is hard to dissipate because the battery cells are wrapped together providing little exposure to the air.

At present, most battery cells, such as nickel-hydrogen cells and Li-ion cells, are made into a cylindrical shape and normalized dimensions. Accordingly, there has been a variety of battery cell supports appearing in the market to let the user fill with batteries with normalized dimensions to form a battery cell module. However, conventional battery cell modules are often made in a factory with one-time formation and thus their shapes/dimensions cannot be easily changed, and also the battery modules with desired power capacity and/or voltage level cannot be made in a simple way by the user.

### SUMMARY OF INVENTION

In the light of the foregoing background, it is an object of the present invention to mitigate or obviate to some degree one or more problems associated with known rechargeable battery modules.

The above object is met by the combination of features of the main claim; the sub-claims disclose further advantageous embodiments of the invention.

One skilled in the art will derive from the following description other objects of the invention. Therefore, the foregoing statements of object are not exhaustive and serve merely to illustrate some of the many objects of the present invention.

Accordingly, the present invention, in one aspect, is a battery cell support for packing a plurality of battery cells, which includes a first supporting member and a second supporting member detachable from the first supporting member. The first supporting member further contains a first fitting mechanism and the second supporting member further contains a second fitting mechanism capable of fitting into the first fitting mechanism such that the first supporting member and the second supporting member are assembled to form the battery cell support. A plurality of battery cells are thus capable of being inserted in a space formed by the first supporting member and the second supporting member.

In a more preferred embodiment, the first supporting member and the second supporting member each further include a hook and a protruding portion. The hook of the first supporting member is capable of fitting in the protruding portion of the second supporting member, and the hook of the second supporting member is capable of fitting in the protruding portion of the first supporting member to form, for example, a clip fit.

In another preferred embodiment, the first supporting member further contains a third fitting mechanism which is on a side of the first supporting member opposite to the first fitting mechanism. The second supporting member further contains a fourth fitting mechanism which is on a side of the second supporting member opposite to the second fitting mechanism. The third fitting mechanism and the fourth fitting mechanisms are capable of connecting or fitting to each other such that two battery cell supports are connectable in a longitudinal direction.

In a further embodiment, the third fitting mechanism further contains a first hook and a positioning hole. The fourth fitting mechanism further contains a second hook and a positioning pin. The first hook is configured to fit in the second hook and the positioning hole is configured to have the positioning pin inserted therein whereby two battery cell supports are connected in the longitudinal or vertical direction.

In another aspect of the present invention, a battery cell module includes a plurality of battery cell supports connected to each other and at least one connecting strap connecting two battery cell supports such that the two battery cell supports are electrically connected. Each battery cell support further contains a first supporting member and a second supporting member detachable from the first supporting member. The first supporting member further contains a first fitting mechanism and the second supporting member further contains a second fitting mechanism capable of fitting the first fitting mechanism such that the first supporting member and the second supporting member are assembled to form the battery cell support. A plurality of battery cells are thus capable of being inserted in a space formed by the first supporting member and the second supporting member.

The summary of the invention does not necessarily disclose all the features essential for defining the invention; the invention may reside in a sub-combination of the disclosed features.

There are many advantages to the present invention. One advantage is that the battery cell support provided in the present invention can be used to assemble together several battery cells of the same specification in a simple and convenient snap-fit approach, to form a modular structure. No bolts or other fasteners are needed for assembling the battery cells using the exemplary embodiments described herein. Also, two or more modules can be joined up laterally in two directions by means of the attachment means such as the aforementioned hooks and slots, or a plurality of modules can be connected together in a longitudinal direction by means of other attachments means such as the aforementioned positioning pins and hook structures as disclosed in the present invention so that battery modules in different shapes, at different voltages, and with different current or power capacities can be formed conveniently. Furthermore, battery modules in odd or irregular shapes may also be formed by the assembling the basic battery blocks, such that the battery module may fit in any container with different shapes/dimensions.

To make battery cell assembly with different voltages or different power capacities, the battery cell support in the present invention is combined with a variety of electrically conductive, e.g. metal connection straps for electrical connection, to meet the demand for different combinations among modules so that a variety of power capacities and/or voltage levels may be provided.

In the battery cell module provided in the present invention, there is certain air gap between battery cells, which is favorable for heat dissipation of the battery cells during use. Also, most of the surfaces of the battery cell are exposed to the outside which enables the user to easily identify the polarity of the battery cell by reading the symbols printed on the surface of the battery cell, so the correct orientation of the battery cell put in the battery cell pack can be ensured.

The battery cell support provided in the present invention is also highly practical and can be designed to work with existing battery cells in a variety of specifications. It is also suitable for mass production and can be widely used by battery manufacturers or battery assembling manufacturers to improve production efficiency and reduce production cost.

### BRIEF DESCRIPTION OF FIGURES

The foregoing and further features of the present invention will be apparent from the following description of preferred embodiments which are provided by way of example only in connection with the accompanying figures, of which:

FIG. 1 is a schematic structural diagram of the battery cell support with battery cells therein, according to one embodiment of the present invention;

FIG. 2 is a sectional view of a battery cell support according to one embodiment of the present invention;

FIG. 3 is an enlarged view of the hook-type snap-fit part of the battery cell support in FIG. 2.

FIG. 4 is a bottom view of the battery cell support in FIG. 1 showing the hooks/slots;

FIG. 5 is a top view of the battery cell support in FIG. 1 showing the hooks/slots;

FIG. 6 is a three-dimensional schematic view of the battery cell support according to one embodiment of the present invention;

FIG. 7 is a three-dimensional exploded view of the battery cell support according to one embodiment of the present invention;

FIG. 8 is a sectional view of joining between battery cell supports in longitudinal direction according to one embodiment of the present invention.

FIG. 9 is a three-dimensional schematic view of joining between battery cell supports in longitudinal direction according to one embodiment of the present invention.

FIG. 10 is a schematic diagram of joining between battery cell supports laterally along length direction according to one embodiment of the present invention.

FIG. 11 is a three-dimensional schematic diagram of joining between battery cell supports laterally along length direction according to one embodiment of the present invention.

FIG. 12 is a schematic diagram of joining between battery cell supports laterally along width direction according to one embodiment of the present invention.

FIG. 13 is a three-dimensional schematic diagram of joining between battery cell supports laterally along width direction according to one embodiment of the present invention.

FIG. 14 shows the internal layout of an electronic device which contains a battery cell module according to one embodiment of the present invention.

FIG. 15 is the block diagram showing the connections of different components in the electronic device in FIG. 14.

### DETAILED DESCRIPTION OF THE PREFERRED EMBODIMENTS

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art, in Australia or any other country.

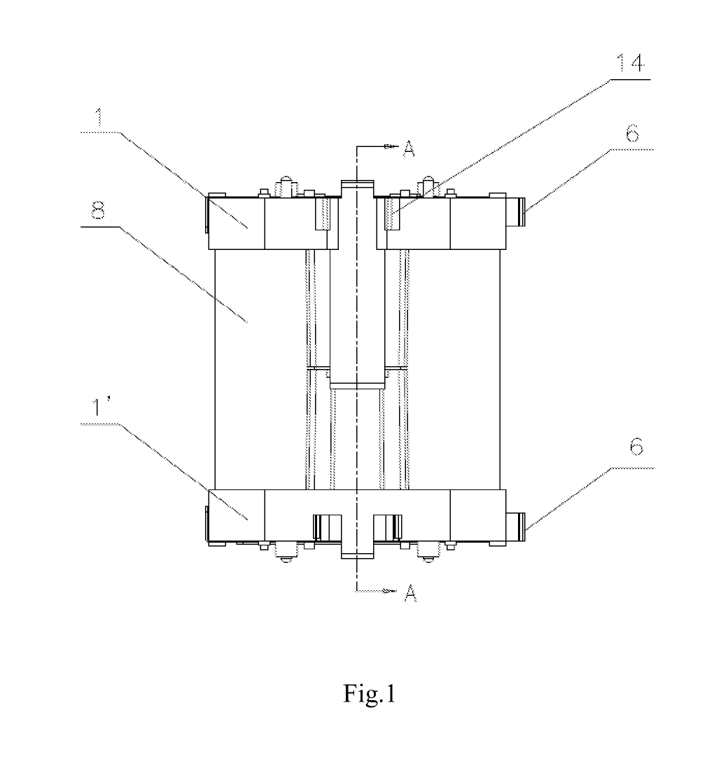

Referring now to FIG. 1, the first embodiment of the present invention is a battery cell support designed to assemble battery cells into a battery cell module. The battery cell support contains two identical battery cell support members 1 and 1′, which are also referred to as the first supporting member and second supporting member. Several battery cells 8 in the same specification can be inserted into the space between two identical battery cell support members 1 and 1′ that face against each other, in a manner that the battery cell support members 1 and 1′ abut the ends of the battery cells 8. The battery cell support also contains various fitting mechanisms such as hooks 6 and a slot 7, of which the functions will be described in detail later.

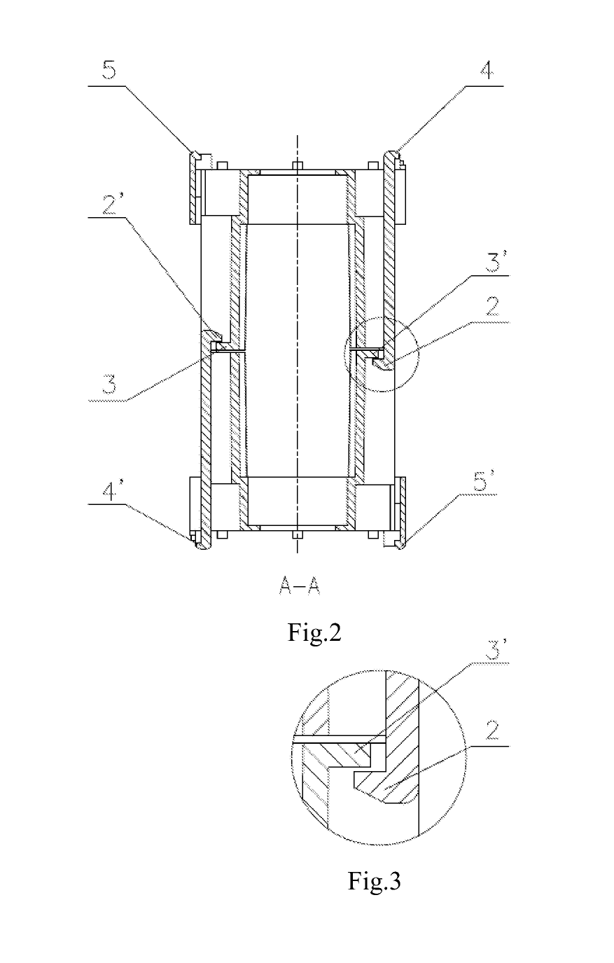

Turning now to FIGS. 2 and 3, the cross-sectional view of the battery cell support shows the various fitting mechanisms or connection means for connecting one battery cell support with other battery cell supports or connecting two battery cell support members to form a battery cell support. As one can see, the hook 2 of battery cell support member 1 is snap fitted to the protruding portion 3′ of the battery cell support member 1′. Meanwhile, the hook 2′ of the battery cell support member 1′ is snap fitted to the protruding portion 3 of the battery cell support 1. As the two identical battery cell support members 1 and 1′ fit in each other by the two fitting mechanisms consisted of hooks and protruding portions, the whole battery cell support is formed. Also, if one wishes to remove or replace the battery in the battery cell support, he can simply separate the two battery cell support members 1 and 1′ by detaching hook 2′ from protruding portion 3 and hook 2 from protruding portion 3′. Neither the assembling nor the separation of the two battery cell support members requires bolts or other connection means. As the two battery cell support members are engaged with each other only by the fitting mechanisms at two points, all the other peripheral spaces surrounding the battery cells are empty to allow most of the surface of the battery cells exposed to the air, which is beneficial to the heat dissipation of the battery cells when they are working. On the other hand, as most of the surfaces of the battery cell are now exposed to the outside, the user can easily identify the polarity of the battery cell by reading the symbols printed on the surface of the battery cell, so the correct orientation of the battery cell put in the battery cell pack can be ensured. Further, there are hooks 4, 5, 4′ and 5′ disposed on the ends of the battery cell support for connecting the battery cell support to other battery cell supports, which will be described later.

In one implementation, the end portion of each battery cell support member which is directly above the positive electrode end or the negative electrode end of a battery cell has a height of around 3.1 mm. A standard rechargeable battery cell has a height of 65 mm, so that the total height of the battery cell support with rechargeable batteries installed is 71.2 mm.

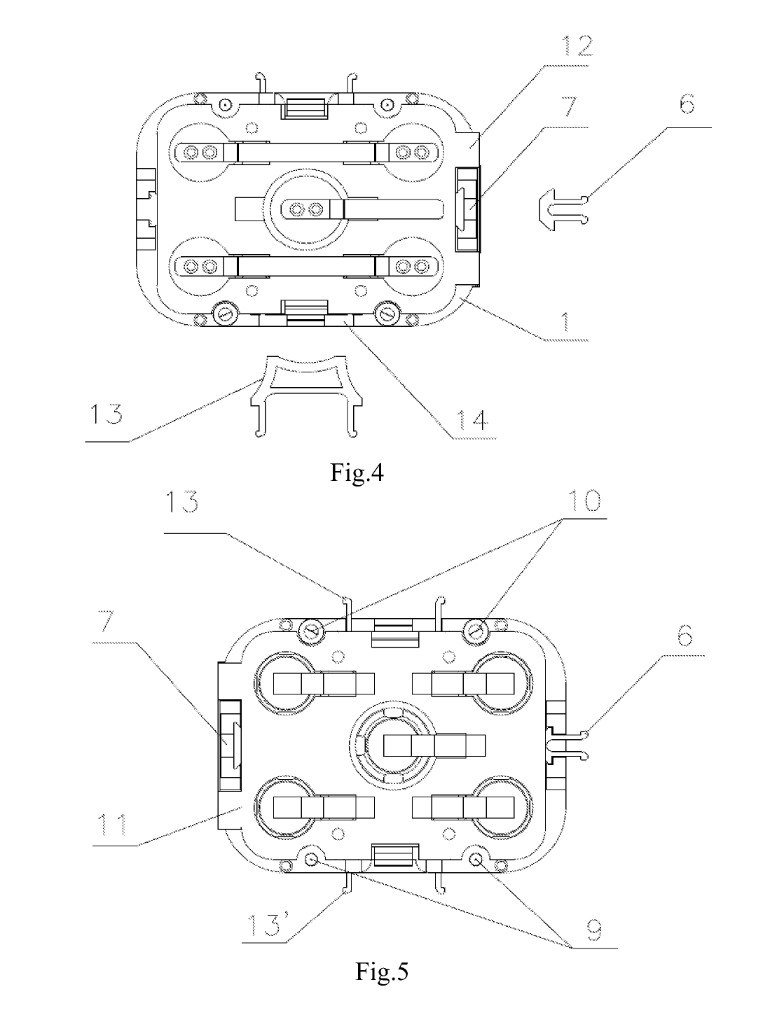

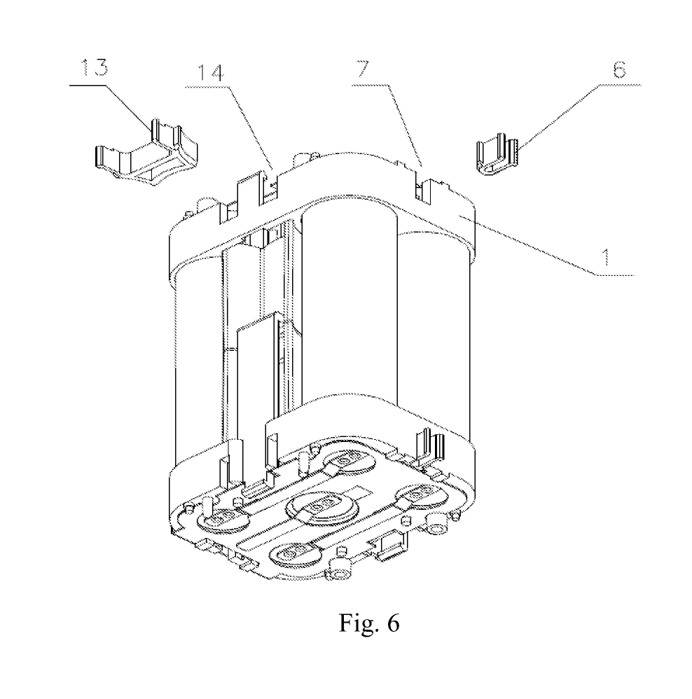

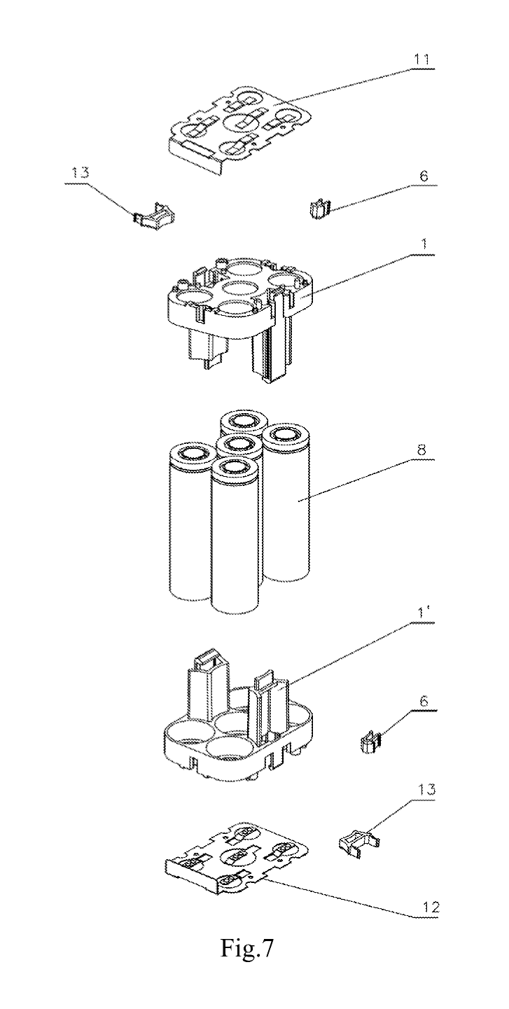

In FIG. 4 and FIG. 5, which show the bottom view and top view of the battery cell support in FIG. 1 respectively, a positive electrical contact strap 11 and a negative electrical contact strap 12 are arranged at respective ends of the battery cell support, i.e., at the positive electrode ends and negative electrode ends of the battery cells. As also shown in FIG. 6 and FIG. 7, the positive strap 11 which electrically connects all the positive electrodes of the battery cells in the battery cell support is located at the battery cell support member 1. The negative strap 12 which electrically connects all the negative electrodes of the battery cells in the battery cell support is located at the battery cell support member 2. The positive strap 11 and negative strap 12 are kept in good electrical contact with the positive electrode ends and negative electrode ends of battery cells through welding or, more preferably, soldering. Slots 14 and 7, as well as hooks like 13, 13′ and 6 are disposed on the positive strap 11 and/or the negative strap 12 at their edges. There are also two positioning holes 9 and two positioning pins 10 on the positive strap 11 and/or the negative strap 12 for stacking multiple battery cell supports.

A battery cell module or assembly with specific power capacity at specific voltage rating is usually formed by a plurality of battery cells connected in series or in parallel. The following description shows how to combine individual battery cell supports in the present invention to form the desired battery cell module.

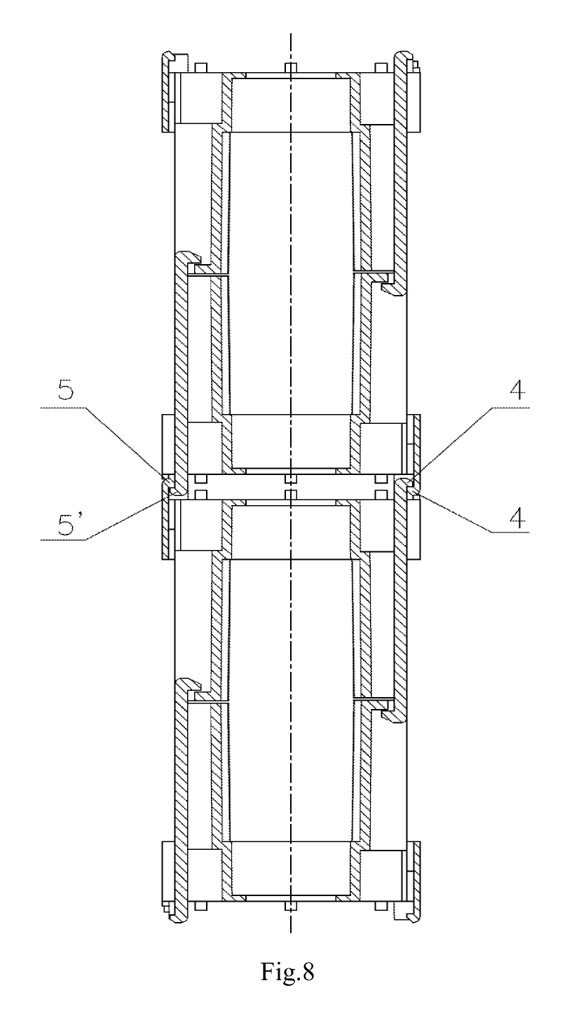

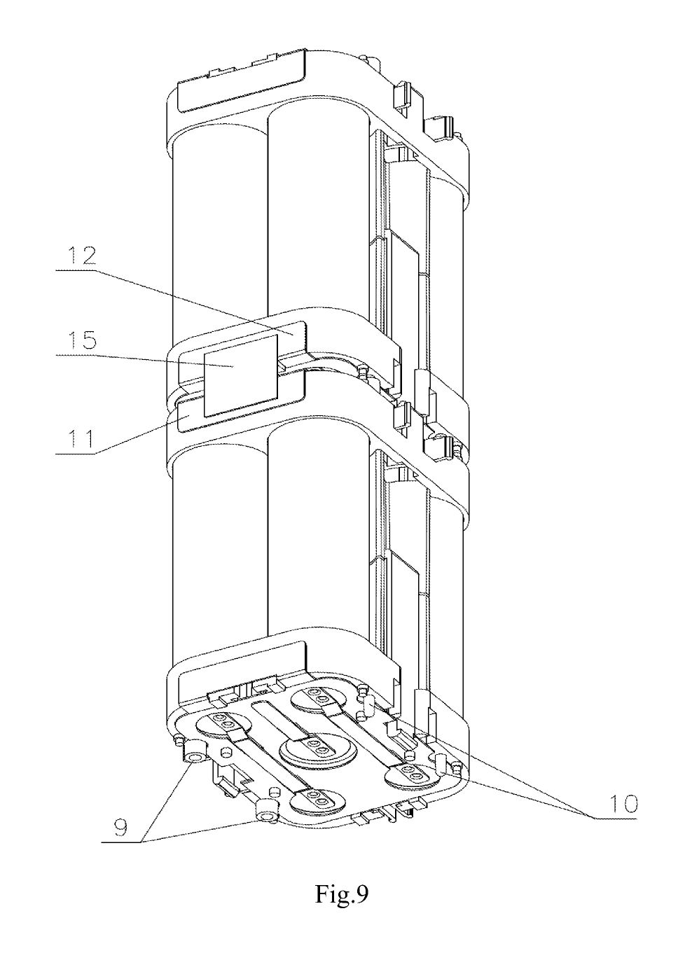

As shown in FIG. 8 and FIG. 9, the battery cell module provided in the present invention is further designed with the above-mentioned hooks 4, 5, positioning hole 9, and positioning pin 10 for connecting the battery cell module with the adjacent battery cell module in longitudinal direction, which are placed on a side of the battery cell support member opposite to the hooks 2, 3, 2′ or 3′. When two or more battery cell modules are aligned in longitudinal direction and the positioning pin 10 is inserted into the positioning hole 9, the hook 4 is snap fitted to the hook 4′ and the hook 5 to the hook 5′ naturally. By the hooking mechanism and positioning pins/holes, two battery cell supports can be readily engaged with each other and form an integrated battery cell assembly. To separate two battery cell supports that are already assembled, one just needs to detach one hook from the other one which is similar to the detaching method for battery cell support members in a single battery cell support. Also, more battery cell supports may also be combined one by one using the above fitting mechanism.

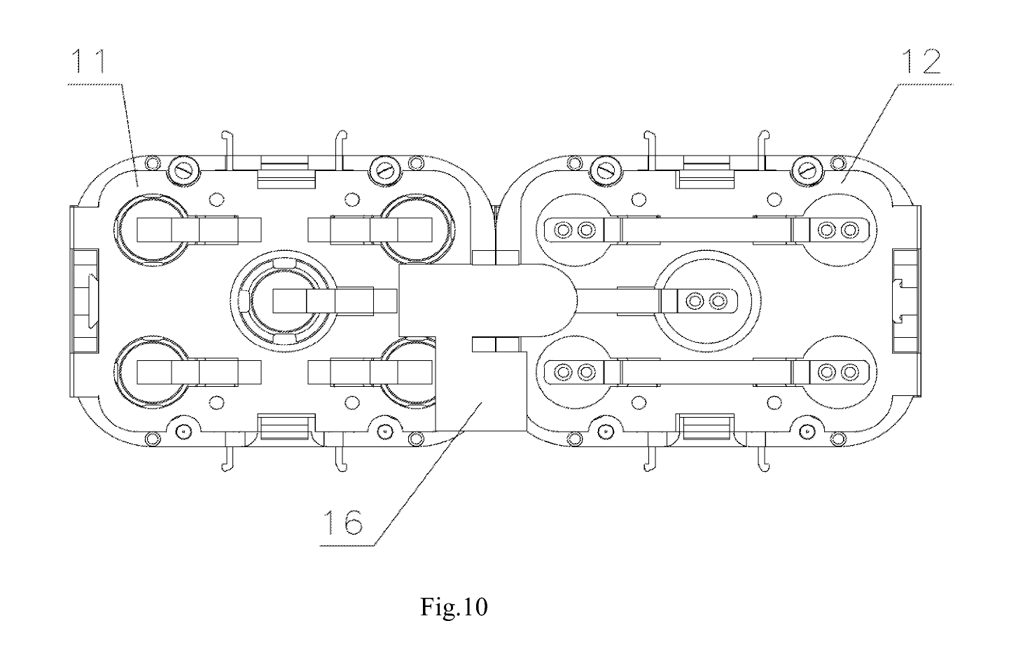

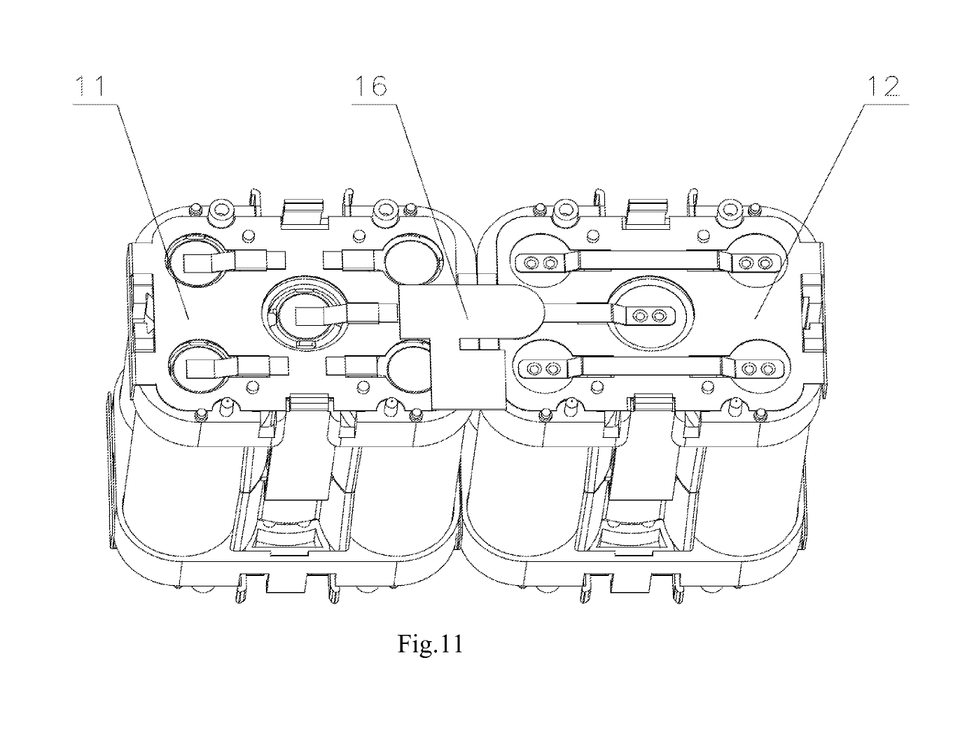

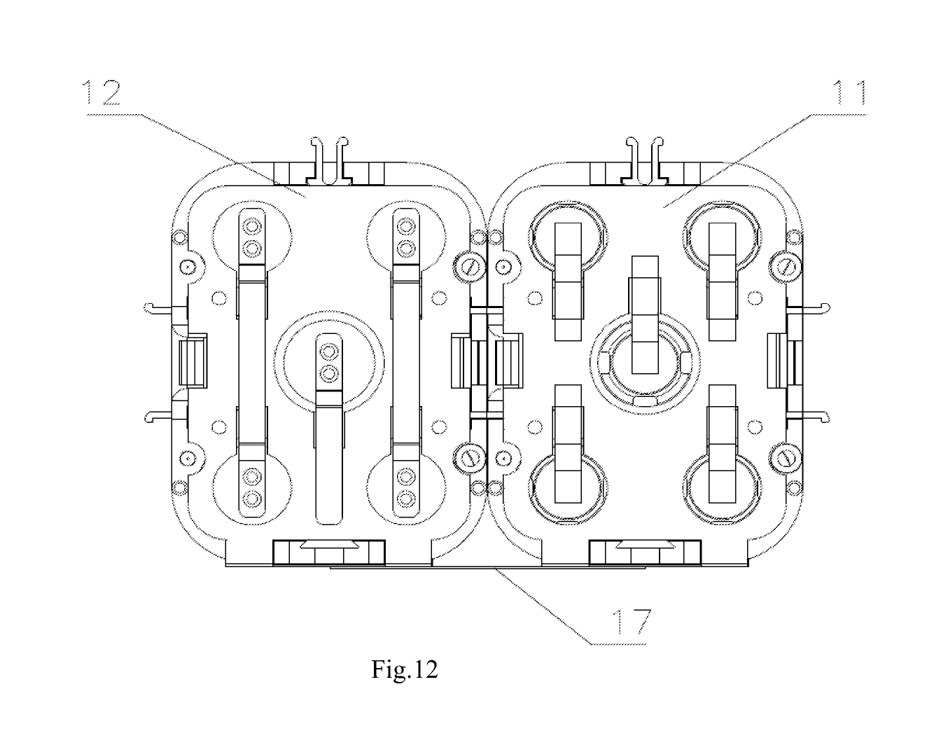

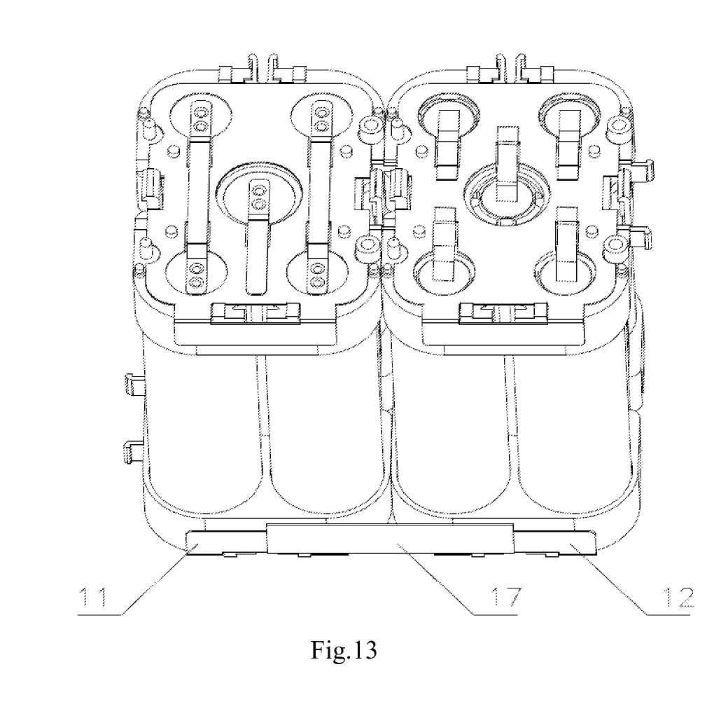

As shown in FIG. 10 and FIG. 11, the battery cell support in the present invention is further designed with a slot 7 for receiving hook 6, two or more battery cell modules can be connected together along their length direction when the hook 6 is set into the slot 7 and the hook 6 of the battery cell module is snap fitted with the slot 7 of the adjacent battery cell module. Similarly, as shown in FIG. 12 and FIG. 13, the battery cell support can also be designed with a slot 14 for receiving hook 13, so that the battery cell module can be snap fitted with the adjacent battery cell module laterally in width direction; when the hook 13 is set into the slot 14 and the hook 13 of the battery cell module is snap fitted with the slot 14 of the adjacent battery cell module, two or more battery cell modules can be connected together along their width direction. The combination of multiple battery cell supports are not limited to those shown in FIG. 8 to FIG. 13, and the battery cell supports may be assembled in a number of different ways in the three-dimensional space like building blocks. The flexible assembling method enables the battery modules to be formed in odd or irregular shapes such that the whole battery module may fit in any container with different shapes/dimensions.

In one embodiment, the battery cell module is further designed with connection straps for electrically connecting battery cell modules which have been snap-fitted to each other. As exemplified in FIG. 9 to FIG. 13, the connection straps may include: longitudinal connection straps 15, which are used to connect positive strap 11 of the battery cell module and negative strap 12 of the adjacent battery module after the battery cell modules being snap-fitted together in longitudinal direction; lateral connection straps 16 arranged on the ends, which are used to connect positive strap 11 of the battery cell module and negative strap 12 of the adjacent battery module after the battery modules being snap-fitted together laterally along length direction; lateral connection straps 17 arranged on the sides, which are used to connect positive strap 11 of the battery cell module and negative strap 12 of the adjacent battery cell module after the battery cell modules being snap-fitted together laterally along width direction. Similar to the above, the electrical connections for the battery cell supports in the present invention can also be made in numerous ways to achieve desired power capacity and/or output voltage level, depending on different needs. This can be done by setting the connections between the battery cell modules to be either in serial connection, parallel connection, or a combination thereof.

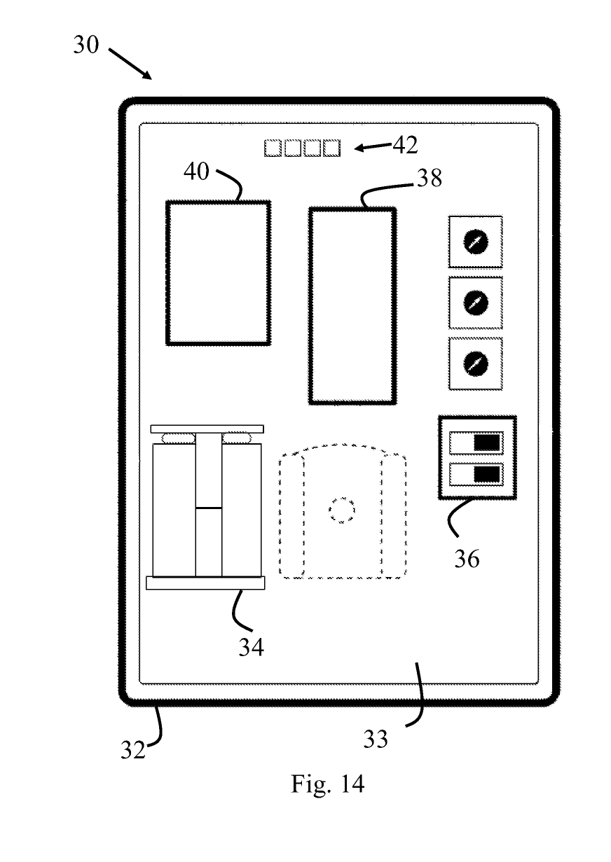

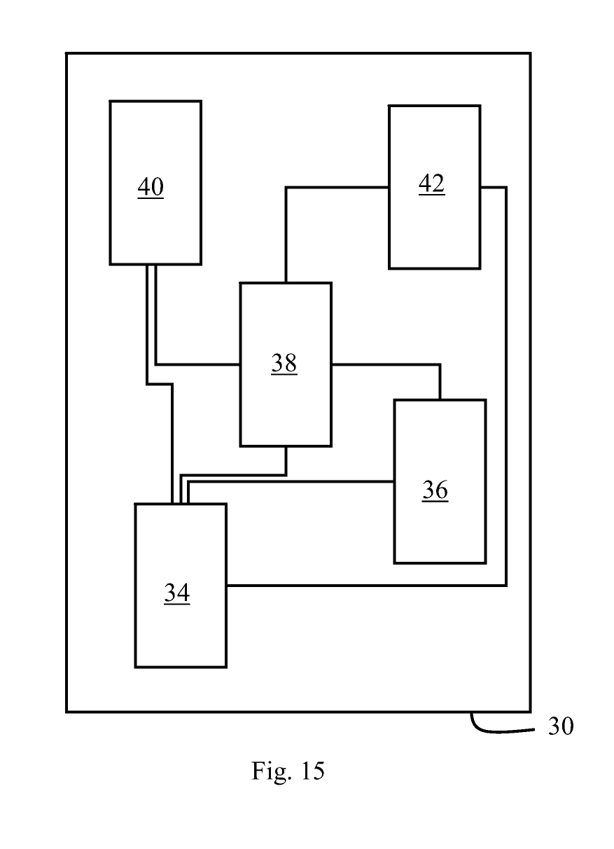

Turning now to FIGS. 14 and 15, in a further aspect of the present invention, an electronic device 30 utilizes the above described battery cell module in the previous embodiments. The device 30 may be a portable device. It may include a case 32 and a circuit board 33 installed in the case 32. The device 30 may have a number of different internal electronic components which include the microcontroller 38, dip switches 36, a storage device 40, and a display 42. One or more of these components may be fixed on the circuit board 33. The battery cell module 34 as shown in FIG. 9 may also be fixed on the circuit board 33. As shown in FIG. 15, the battery cell module 34 is electrically connected to the other components on the circuit board 33 which includes the microcontroller 38, the dip switches 36, the storage device 40 and the display 42, and provides electric power to these internal components for their operations. The microcontroller 38 is connected to the dip switches 36, the storage device 40 and the display 42 to control these components and acts as an exchange for any signal/data. The battery cell module 34 comprising a plurality of battery cell supports according to the invention may be shaped to fit in a space around other components of the device or apparatus 30. This space may be of non-uniform or irregular shape, but the configurability of the battery cell supports provided by their attachment means makes it possible to connect said battery cell supports to form a battery cell module 34 of non-regular geometric shape or configuration that makes best use of the available space between and/or around other components within the housing of the electronic device 30. Note that the electronic device 30 described here is just for illustration purpose only to show a practical application of the battery cell module in the present invention. One with ordinary skills in the art should realize that the applications of the battery cell module are not limited hereby, as the battery cell module may also be utilized in any other electronic device that requires a power supply.

The exemplary embodiments of the present invention are thus fully described. Although the description referred to particular embodiments, it will be clear to one skilled in the art that the present invention may be practiced with variation of these specific details. Hence this invention should not be construed as limited to the embodiments set forth herein.

The embodiments of the present invention described above mainly use hook/slot as the fitting mechanism for fastening different components. Fasteners in a variety of specifications can be designed in conjunction with battery cells in proper specifications according to the above descriptions. However, all such fasteners shall be considered to be within the scope of the present invention which is disclosed by the claims.

Although in the exemplary embodiments as described above, the two battery cell support members are identical, one skilled in the art should realize that the two members may also be designed to be different with special structural characteristics to meet different requirements for the battery cell module.

As described above, metal straps are used to electrically connect two battery cell supports as shown in FIG. 9 to FIG. 13. However, other kinds of connecting means may also be applied such as using an electric wire.

In the preferred embodiments described above, the battery cell support is to be installed in an electronic device. However, it is clear to those skilled in the art that the application of the battery cell support is not limited to a specific electronic device, but it can also be used in any other apparatus where the battery as a power source is required, such as a vehicle, a vessel, an aircraft, etc.

In general, the present invention discloses a battery cell support comprising a first supporting member and a second supporting member, which are assembled by a first fitting mechanism and a second fitting mechanism on the supporting member that can be snap-fit in each other. Battery cells are inserted in the space formed by the first supporting member and the second supporting member with exposed surface such that proper heat dissipation of the battery cells is ensured. An assembly of multiple battery cell supports is also disclosed which uses different fitting mechanisms to combine the separate battery cell supports, and also a metal strap is used to electrically connect the separate battery cell supports. A method of manufacturing a battery pack is also disclosed.

What is claimed is:

1. A battery cell support for packing a plurality of battery cells, comprising:
a) a first supporting member, said first supporting member further comprising a first fitting mechanism; and
b) a second supporting member detachable from said first supporting member; said second supporting member further comprising a second fitting mechanism capable of fitting in said first fitting mechanism such that said first supporting member and said second supporting member being assembled to form said battery cell support;
whereby a plurality of battery cells are capable of being inserted in a space formed by said first supporting member and said second supporting member.

2. The battery cell support of claim 1, wherein said first supporting member and said second supporting member each further comprises a hook and a protruding portion; said hook of said first supporting member capable of fitting in said protruding portion of said second supporting member and said hook of said second supporting member capable of fitting in said protruding portion of said first supporting member.

3. The battery cell support of claim 1, wherein said first supporting member further comprises a third fitting mechanism, said third fitting mechanism being on a side of said first supporting member opposite to said first fitting mechanism; said second supporting member further comprises a fourth fitting mechanism, said fourth fitting mechanism being on a side of said second supporting member opposite to said second fitting mechanism; said third fitting mechanism and said fourth fitting mechanism capable of fitting in each other such that two said battery cell supports are connected in a longitudinal direction.

4. The battery cell support of claim 3, wherein said third fitting mechanism further comprises a first hook and a positioning hole; said fourth fitting mechanism further comprising a second hook and a positioning pin; said first hook configured to fit in said second hook and said positioning hole configured to have said positioning pin inserted therein whereby said two battery cell supports are connected in said longitudinal direction.

5. The battery cell support of claim 1, wherein said first supporting member further comprises a third fitting mechanism; said third fitting mechanism capable of fitting in said third fitting mechanism on another said battery cell support, such that two said battery cell supports are connected in a horizontal direction.

6. The battery cell support of claim 5, wherein said third fitting mechanism further comprises a hook and a slot, said hook and said slot configured to be fitting into each other.

7. The battery cell support of claim 1 further comprises a positive strap and a negative strap installed on said first fitting mechanism and said second fitting mechanism respectively; said positive strap electrically connecting to positive poles of said plurality of battery cells and said negative strap electrically connecting to negative poles of said plurality of battery cells.

8. A battery cell module comprising:
a) a plurality of battery cell supports connected to each other; each said battery cell support further comprising
i. a first supporting member, said first supporting member further comprising a first fitting mechanism; and
ii. a second supporting member detachable from said first supporting member; said second supporting member further comprising a second fitting mechanism fitting into said first fitting mechanism such that said first supporting member and said second supporting member being assembled into said battery cell support; whereby a plurality of battery cells capable of being inserted in a space formed by said first supporting member and said second supporting member;
b) at least one connecting strap connecting two said battery cell supports such that said two battery cell supports are electrically connected.

9. The battery cell module of claim 8 further comprises two battery cell supports connected to each other in a longitudinal direction; said connecting strap electrically connecting said first supporting member of one said battery cell support to said second supporting member of the other said battery cell support.

10. The battery cell module of claim 9, wherein said first supporting members further comprise positive straps and said second supporting members further comprise negative straps; said connecting strap electrically connecting said positive strap on said first supporting member of one said battery cell support to said negative strap on said second supporting member of the other said battery cell support whereby said two battery cell modules are connected in series.

11. The battery cell module of claim 8 further comprises two battery cell supports connected to each other in a horizontal direction, a first connecting strap and a second connecting strap; said first connecting strap electrically connecting said first supporting member of one said battery cell support to said first supporting member of the other said battery cell support; said second connecting strap electrically connecting said second supporting member of one said battery cell support to said second supporting member of the other said battery cell support.

12. The battery cell module of claim 11, wherein said first supporting members further comprise positive straps and said second supporting members further comprise negative straps; said first connecting strap electrically connecting said positive strap on said first supporting member of one said battery cell support to said positive strap on said second supporting member of the other said battery cell support; said second connecting strap electrically connecting said negative strap on said first supporting member of one said battery cell support to said negative strap on said second supporting member of the other said battery cell support; whereby said two battery cell modules are connected in parallel.

13. The battery cell module of claim 8 further comprises two battery cell supports connected to each other in a horizontal direction and a connecting; said connecting strap electrically connecting said first supporting member of one said battery cell support to said second supporting member of the other said battery cell support.

14. The battery cell module of claim 13, wherein said first supporting members further comprise positive straps and said second supporting members further comprise negative straps; said connecting strap electrically connecting said positive strap on said first supporting member of one said battery cell support to said negative strap on said second supporting member of the other said battery cell support; whereby said two battery cell modules are connected in series.

15. A method of manufacturing a battery pack, comprising the steps of:
a) providing a battery cell support for packing a plurality of battery cells, comprising:
i. a first supporting member, said first supporting member further comprising a first fitting mechanism; and
ii. a second supporting member detachable from said first supporting member; said second supporting member further comprising a second fitting mechanism capable of fitting in said first fitting mechanism such that said first supporting member and said second supporting member being assembled to form said battery cell support; and
b) inserting a plurality of battery cells in a space formed by said first supporting member and said second supporting member.

16. An apparatus comprising:
a) a battery cell support for packing a plurality of battery cells, which further comprising:
i. a first supporting member, said first supporting member further comprising a first fitting mechanism; and
ii. a second supporting member detachable from said first supporting member; said second supporting member further comprising a second fitting mechanism capable of fitting in said first fitting mechanism such that said first supporting member and said second supporting member being assembled to form said battery cell support; and
b) at least one internal component electrically connected to said battery cell support; said battery cell support providing electric power to said internal component so that said internal component operates.
